(19) United States
(12) Patent Application Publication
(10) Pub. No.: US 2013/0243117 A1
(43) Pub. Date: Sep. 19, 2013

(54) APPARATUS AND METHOD FOR A FLEXIBLE DIGITAL PREDISTORTION ARCHITECTURE FOR COARSE-TO-FINE COMPENSATION

(71) Applicant: Ernesto G. Jeckeln, Richardson, TX (US)

(72) Inventor: Ernesto G. Jeckeln, Richardson, TX (US)

(73) Assignee: Samsung Electronics Co., Ltd., Suwon-si (KR)

(21) Appl. No.: 13/419,098

(22) Filed: Mar. 13, 2012

(51) Int. Cl. H04L 25/49

(52) U.S. Cl. 375/296

(57) ABSTRACT

A transmitting device comprises a non-linear amplifier and a digital predistortion (DPD) circuit. The digital predistortion (DPD) circuit comprises: i) a coarse distortion compensator configured to receive an input signal and to generate a coarse distortion compensation signal; ii) a fine distortion compensator configured to receive the input signal and to generate a fine distortion compensation signal; and iii) a summing circuit that combines the coarse distortion compensation signal and the fine distortion compensation signal to generate a pre-distorted input signal to the non-linear amplifier.

### TECHNICAL FIELD OF THE INVENTION

The present application relates generally to a flexible digital pre-distortion (DPD) architecture for use in ultra-wideband wireless transmission systems.

### BACKGROUND OF THE INVENTION

The current trend in developing highly linear multi-carrier radio frequency (RF) and microwave transmitters driven by ultra-wideband signals puts pressure on digital pre-distortion (DPD) system designers to focus on more sophisticated algorithms and model topologies that allow reducing the very high sampling rate needed to capture data and generate pre-distortion components. It is well understood that an N^{th}-order DPD output signal stretches out to N times the modulation bandwidth, thereby imposing a very high Nyquist rate. Thus, N times the complex signal bandwidth is to be distorted. This is the complex bandwidth that occupies the N^{th}-order intermodulation distortion and that has a sampling rate defined by the real components I/Q of the distorted complex signal.

However, this is not the case in the process of generating the pre-distortion components, where the sampling rate is defined by the real bandwidth of the envelope waveform. A generic DPD model uses the envelope waveform of the modulated complex signal to index a correlated instantaneous predistortion level. Because the envelope component has a larger bandwidth in comparison to its correlated complex signal bandwidth, the Nyquist rate is governed by the real bandwidth of the envelope waveform and not by the real bandwidth of the I/Q components.

This increases the sampling rate beyond the Nyquist rate of the I/Q components to support all distortion components included in the envelope waveform. Therefore, it would be desirable to implement an algorithm that employs the lowest possible sampling rate of the DPD model while preserving the optimal dynamic behavior of all predistortion components generated by the DPD model. In addition, it would be desirable to have a flexible DPD architecture that could efficiently generates predistortion components for different conditions of nonlinearity presented by different multi-carrier RF and microwave transmitters.

Some of the prior art disclosures that discuss the above-mentioned limitations include:

REF1—ALTERA Corporation website at:

http://www.altera.com /buy/buy-index.html;

REF2—U.S. Pat. No. 6,118,335, entitled “Method And Apparatus For Providing Adaptive Predistortion In Power Amplifier And Base Station Utilizing The Same”, to Nielsen et al.;

REF3—U.S. Pat. No. 6,281,936, entitled “Broadcast Transmission System With Sampling And Correction Arrangement For Correcting Distortion Caused By Amplifying And Signal Conditioning Components”, to Twitchell et al.;

REF4—U.S. Pat. No. 6,335,767, entitled “Broadcast Transmission System With Distributed Correction”, to Twitchell;

REF5—U.S. Pat. No. 6,501,805, entitled “Broadcast Transmission System With Single Correction Filter For Correcting Linear And Nonlinear Distortion”, to Twitchell;

REF6—U.S. patent application Ser. No. 09/954,088, entitled “Digitally Implemented Predistorter Control Mechanism For Linearizing High. Efficiency RF Power Amplifiers”, to Cova;

REF7—U.S. Pat. No. 6,642,786, entitled “Piecewise Polynomial Predistortion Method And Apparatus For Compensating Nonlinear Distortion Of High Power Amplifier”, to Jin et al.;

REF8—U.S. Pat. No. 6,141,390, entitled “Predistortion In A Linear Transmitter Using Orthogonal Kernels”, to Cova et al.;

REF9—U.S. Pat. No. 6,798,843, entitled “Wideband Digital Predistortion Linearizer For Nonlinear Amplifier”, to Wright et al.;

REF10—U.S. Pat. No. 7,269,231, entitled “System And Method For Predistorting A Signal Using Current And Past Signal Samples”, to Ding et al.; and

REF11—U.S. Pat. No. 7,035,345, entitled “Adaptive Predistortion Device And Method Using Digital Receiver”, to Jeckeln et al.

The above-listed references (REF1-REF11) are hereby incorporated into the present disclosure as if fully set forth herein.

### SUMMARY OF THE INVENTION

To address the above-discussed deficiencies of the prior art, it is a primary object to provide an improved transmitting device. The transmitting device comprises a non-linear amplifier and a digital predistortion (DPD) circuit. The digital predistortion (DPD) circuit comprises: i) a coarse distortion compensator configured to receive an input signal and to generate a coarse distortion compensation signal; ii) a fine distortion compensator configured to receive the input signal and to generate a fine distortion compensation signal; and iii) a summing circuit that combines the coarse distortion compensation signal and the fine distortion compensation signal to generate a pre-distorted input signal to the non-linear amplifier.

In an advantageous embodiment, the transmitting device further comprises a coarse distortion identification circuit configured to receive an output signal of the non-linear amplifier and to generate first updated coefficients to be used by the coarse distortion compensator.

In another advantageous embodiment, the transmitting device further comprises a fine distortion identification circuit configured to receive the output signal of the non-linear amplifier and to generate second updated coefficients to be used by the fine distortion compensator.

It is another primary object to provide an improved transmitting device. The transmitting device comprises a non-linear amplifier and a digital predistortion (DPD) circuit. The digital predistortion (DPD) circuit comprises i) a coarse distortion compensator configured to receive an input signal and to generate a coarse distortion compensation signal; and ii) a fine distortion compensator configured to receive the coarse distortion compensation signal and to generate a pre-distorted input signal to the non-linear amplifier.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that includes mobile stations and base stations that implement flexible digital pre-distortion (DPD) architecture according to the principles of the present disclosure;

FIG. 2 illustrates a flexible digital predistortion (DPD) model according to an exemplary embodiment of the present disclosure;

FIG. 3 illustrates an additive connection circuit block according to an exemplary embodiment of the disclosure;

FIG. 4 illustrates a cascade connection circuit block according to an exemplary embodiment of the disclosure;

FIG. 5 illustrates a block diagram of coarse compensator in a multiple-input, multiple-output (MIMO) configuration;

FIG. 6 illustrates a block diagram of a fine compensator according to one embodiment of the disclosure;

FIG. 7 illustrates a block diagram of transmission path circuitry that includes a cascade connection circuit block according to an exemplary embodiment of the disclosure; and

FIG. 8 illustrates a block diagram of transmission path circuitry that includes an additive connection circuit block according to an exemplary embodiment of the disclosure.

### DETAILED DESCRIPTION OF THE INVENTION

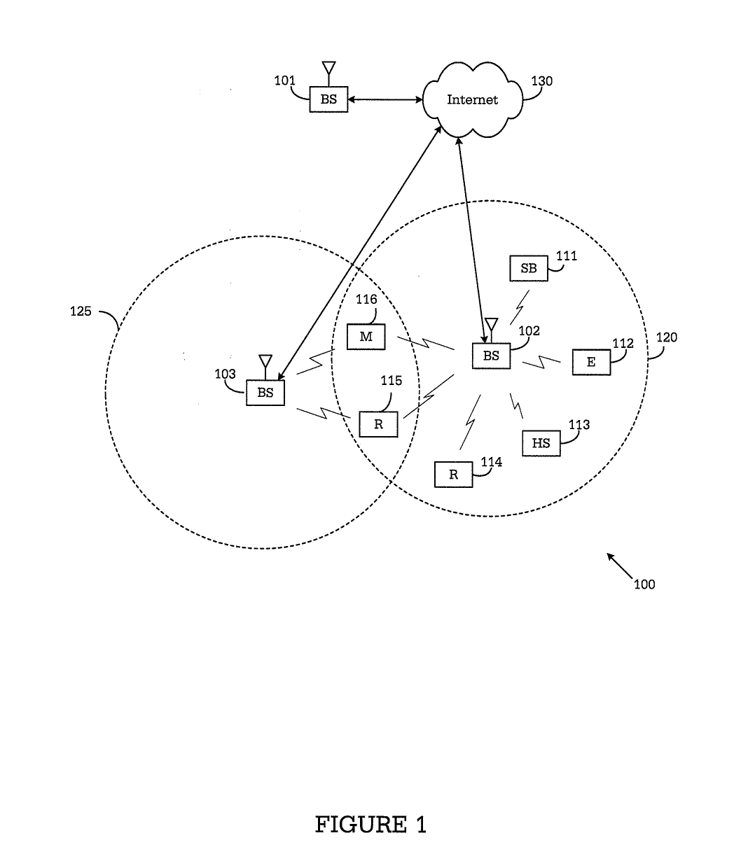

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless network.

The present application relates generally to a flexible digital pre-distortion (DPD) architecture for use in ultra-wideband wireless transmission systems. It is applicable to various digital communication systems where the efficiency and cost considerations of the power amplifier are important factors. In particular, this disclosure is applicable to cellular phones and 3G/4G base stations of wireless communication systems (e.g., WIMAX, LTE-A, and the like).

FIG. 1 illustrates exemplary wireless network 100, which includes mobile stations and base stations that implement flexible digital pre-distortion (DPD) architecture according to the principles of the present disclosure. Wireless network 100 includes base station (BS) 101, base station (BS) 102, base station (BS) 103, and other similar base stations (not shown). Base station 101 is in communication with Internet 130 or a similar IP-based network (not shown).

Depending on the network type, other well-known terms may be used instead of “base station,” such as “eNodeB” or “access point”. For the sake of convenience, the term “base station” shall be used herein to refer to the network infrastructure components that provide wireless access to remote terminals.

Base station 102 provides wireless broadband access to Internet 130 to a first plurality of mobile stations within coverage area 120 of base station 102. The first plurality of subscriber stations includes mobile station 111, which may be located in a small business (SB), mobile station 112, which may be located in an enterprise (E), mobile station 113, which may be located in a WiFi hotspot (HS), mobile station 114, which may be located in a first residence (R), mobile station 115, which may be located in a second residence (R), and mobile station 116, which may be a mobile device (M), such as a cell phone, a wireless laptop, a wireless PDA, or the like.

Base station 103 provides wireless broadband access to Internet 130 to a second plurality of mobile stations in coverage area 125 of base station 103. The second plurality of mobile stations includes mobile station 115 and mobile station 116. In an exemplary embodiment, base stations 101-103 may communicate with each other and with mobile stations 111-116 using broadband (or wideband) techniques, and frequency division duplexing (FDD) or time division duplexing (TDD) techniques.

The present disclosure proposes a robust digital predistortion (DPD) model that provides a reduced sampling rate for a wideband signal in conjunction with a flexible architecture to support different nonlinear behaviors. It is suitable for dynamic system identification where the model parameters are estimated from a coarse scale to a fine scale.

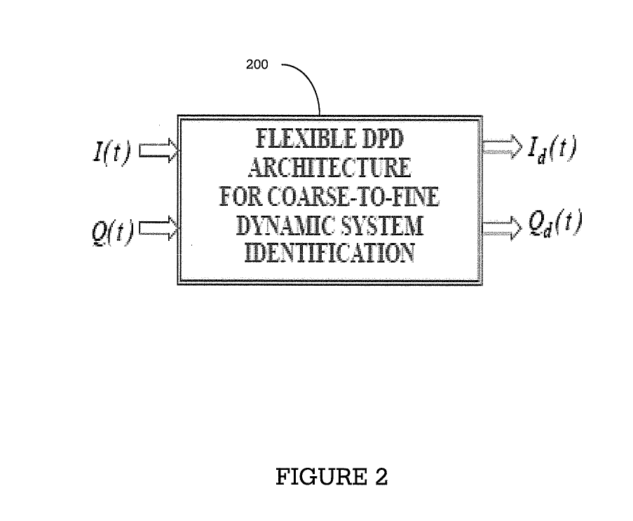

FIG. 2 illustrates flexible digital predistortion (DPD) model 200 according to an exemplary embodiment of the present disclosure. Digital predistortion (DPD) model 200 is a digital signal processor (DSP) circuit block located in the forward path of the wideband transmitter, where the signal processing is performed on-line (i.e., in real time). The DSP is implemented in order to be fitted into a real system as a bit-rate filter operating on an in-phase, I(t), input data stream and a quadreature, Q(t), input data stream. The signal components, I(t) and Q(t), which pass through the DPD block, and the corresponding distorted versions, I_{d}(t) and Q_{d}(t), represent complex signals in Cartesian form whose data type are 16 bit integers.

The DPD block represents a nonlinear system that generates distortion throughout the interconnection between two nonlinear subsystems, where one nonlinear subsystem processes the coarse distortion and the other nonlinear subsystem processes the fine distortion. The DPD model may be configured using an additive distortion connection or a cascade distortion connection.

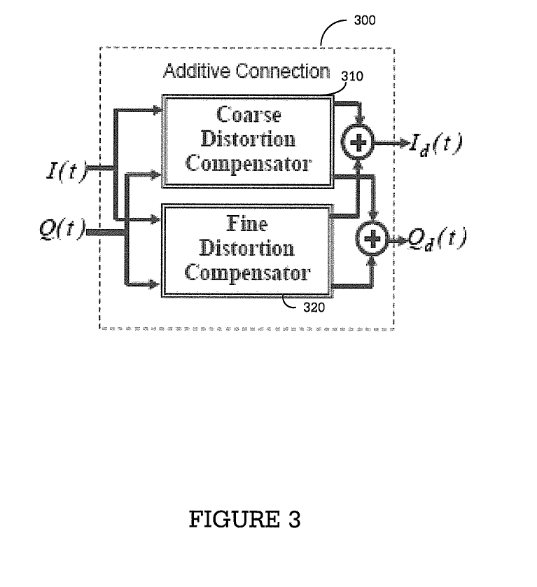

FIG. 3 illustrates additive connection circuit block 300 according to an exemplary embodiment of the disclosure. In additive connection circuit block 300, coarse distortion compensator 310 and fine distortion compensator 320 are connected in parallel. The distorted components I_{d}(t) and Q_{d}(t) result from the addition of both coarse and fine distortions.

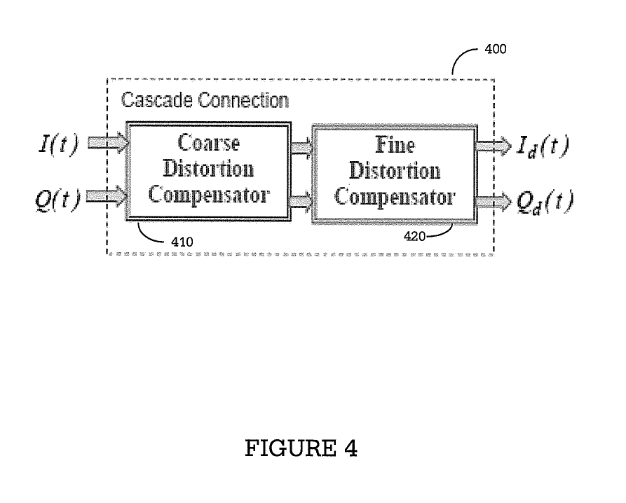

FIG. 4 illustrates cascade connection circuit block 400 according to an exemplary embodiment of the disclosure. In cascade connection circuit block 400, the distorted components from coarse distortion compensator 410 serve as the input to fine distortion compensator 420 to generate the output distorted components I_{d}(t) and Q_{d}(t).

In both the additive connection and the cascade connection, the compensatory predistortion components emerging from the coarse and fine block are considered together and conform to the connection to form unique distortion compensation components at the output of the DPD.

In order to reduce the minimum sampling rate of the model, the DPD model kernels are expressed as function of the I and Q components of the complex signal. It allows the Nyquist rate to be governed by the real bandwidth of the I and Q components and not by the envelope bandwidth. In this case, the sampling rate may be substantially reduced by almost 50% of the theoretical envelope bandwidth.

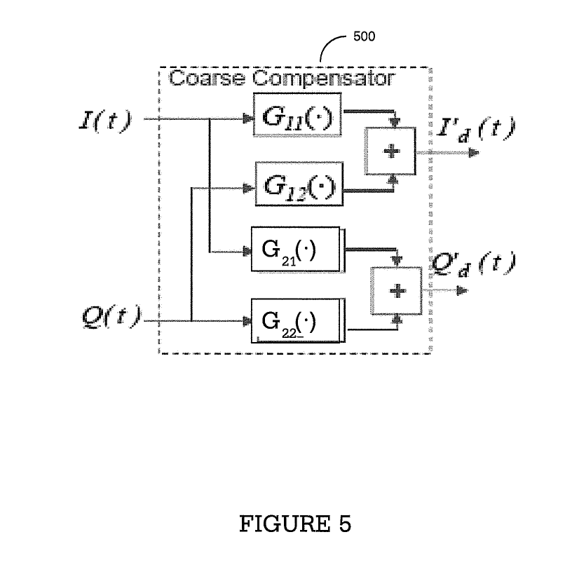

FIG. 5 illustrates a block diagram of coarse compensator 500 in a multiple-input, multiple-output (MIMO) configuration. In this embodiment, it is defined as two-input, two-output variables. The functions G11, G12, G21, and G22 require one dimension to map one variable from the input to one variable at the output. Such a mapping may be implemented using four one-dimensional (1D) look up tables (LUTs). The synthesis of all G functions may be performed using the following equations:

$$\begin{matrix}{I}_{d} ( t ) = {G}_{11} I ( t ) + {G}_{12} Q ( t ) \\ {Q}_{d} ( t ) = {G}_{21} I ( t ) + {G}_{22} Q ( t ) , & [ Eqn . 1 ] \\ [ \begin{matrix}{I}_{d} ( t ) \\ {Q}_{d} ( t )\end{matrix} ] = [ \begin{matrix}{G}_{11} & {G}_{12} \\ {G}_{21} & {G}_{22}\end{matrix} ] [ \begin{matrix}I ( t ) \\ Q ( t )\end{matrix} ] , & [ Eqn . 2 ]\end{matrix}$$

The parameter extractions are performed based on least squares criteria, considering the measurements of the input and output of the complex system to be modeled. It is important to mention that coarse compensator 500 generates most of the total energy of all the distortion components from the lowest to the highest frequencies.

The residual distortion (small amount of energy) generated by the fine compensator is mostly governed by lower order IM distortion closer to the principal lobule of the envelope. This allows applying some type of bandwidth reduction algorithm that may reduce only in the frequency region of the highest order IM distortion without changing the dynamic behavior of the distortion components of lower order. In this case, the fine compensator block will be relaxed in terms of sampling rate being lower than the minimum sampling rate required by the coarse compensator.

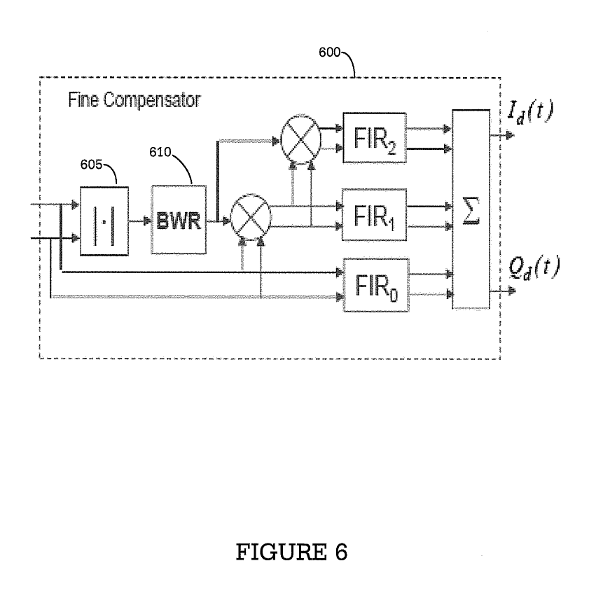

FIG. 6 illustrates a block diagram of fine compensator 600 according to one embodiment of the disclosure. Fine compensator 600 has a 3^{rd} order polynomial topology. Fine compensator 600 comprises a bank of three FIR filters (FIR₀, FIR₁, FIR₂), each having p coefficients. The polynomial filter comprises a first order or linear branch (FIR₀), a 2^{nd} order branch (FIR₁), and a 3^{rd} order branch (FIR₂). It is configured to generate any residual nonlinear distortion that coarse compensator 500 did not generate correlated to the measurements data.

It is noted that fine compensator 600 includes a processing block 605 to compute the envelope waveform of the input complex signal. In addition, fine compensator 600 includes a bandwidth reduction (BWR) block 610 to reduce the bandwidth of the envelop signal. BWR block 610 may be implemented using, for example, look-up tables, or some type of shaping filter that shapes the sharp valleys of the envelope. The sharp dips reflect abrupt changes that generate a broad spectral profile in the envelope signal. By shaping the sharp valleys of the envelope signal, the signal bandwidth may be reduced. The non-linear filter is represented by the following equation:

$$y ( n ) = {\sum }_{i = 1}^{p} {a}_{1 i} \cdot x ( n - i ) + {\sum }_{i = 1}^{p} {a}_{2 i} \cdot x ( n - i ) \cdot \vert x ( n - i ) \vert + {\sum }_{i = 1}^{p} {a}_{3 i} \cdot x ( n - i ) \cdot {\vert x ( n - i ) \vert}^{2}$$

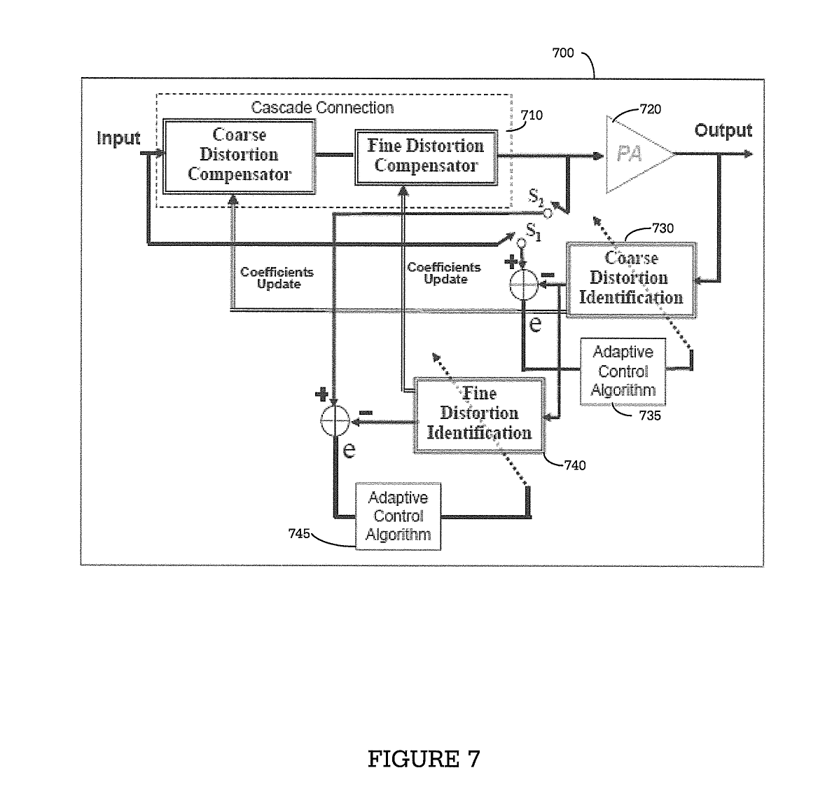

FIG. 7 illustrates a block diagram of transmission path circuitry 700 that includes cascade connection circuit block 710 according to an exemplary embodiment of the disclosure. Cascade connection circuit block 710 receives a complex input signal and performs a digital predistortion (DPD) algorithm to generate a predistorted output signal that is the input signal to power amplifier (PA) 720.

Cascade connection circuit block 710 compensates for the nonlinearity characteristics of PA 720 by generating predistortion components that offset or compensate for the distortion caused by the nonlinearity of PA 720. The scheme includes digital signal processing (DSP) blocks representing the off-line (i.e., non-real time) processing of coarse distortion identification block 730 and fine distortion identification block 740 in conjunction with adaptive control algorithm blocks 735 and 745.

As noted, in this structure, the DPD model uses cascade connection 710. The sequences for parameters extraction are performed as follow. In the 1^{st} step, the parameters extraction for Coarse Distortion Compensator is achieved by considering the switch S₁ is ON, switch S₂ is OFF, and the Fine Distortion Compensator as a complex gain equal to one. In the 2^{nd} step, the parameters extraction for Fine Distortion Compensator is achieved by considering the switch S₁ is OFF, and switch S₂ is ON.

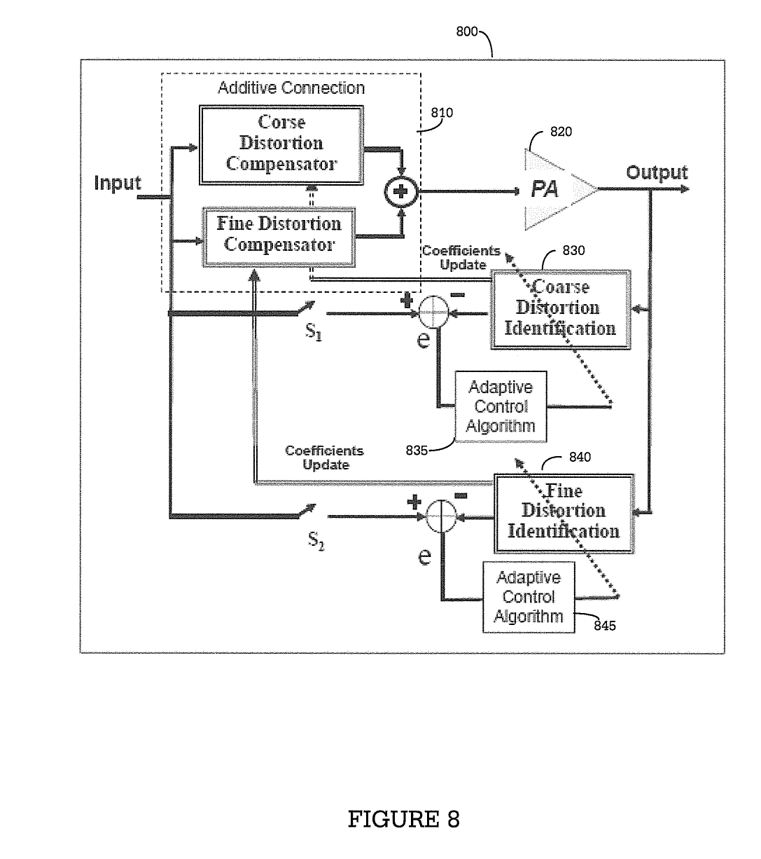

FIG. 8 illustrates a block diagram of transmission path circuitry 800 that includes additive connection circuit block 810 according to an exemplary embodiment of the disclosure. Based on the same concept of distortion cancelation discussed in FIG. 7, transmission path circuitry 800 shows a similar algorithm block diagram of signal amplification using additive connection. The sequences for parameter extractions are performed as follow. In the 1^{st} step, the parameter extraction for the coarse distortion compensator is achieved by considering switch S₁ is ON, switch S₂ I OFF, and the fine distortion compensator as a complex gain equal to zero. In the 2^{nd} step, the parameter extraction for the fine distortion compensator is achieved by considering switch S₁ is OFF and switch S₂ is ON.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A transmitting device comprising:
a non-linear amplifier; and
a digital predistortion (DPD) circuit comprising:
a coarse distortion compensator configured to receive an input signal and to generate a coarse distortion compensation signal;
a fine distortion compensator configured to receive the input signal and to generate a fine distortion compensation signal; and
a summing circuit that combines the coarse distortion compensation signal and the fine distortion compensation signal to generate a pre-distorted input signal to the non-linear amplifier.

2. The transmitting device as set forth in claim 1, further comprising a coarse distortion identification circuit configured to receive an output signal of the non-linear amplifier and to generate first updated coefficients to be used by the coarse distortion compensator.

3. The transmitting device as set forth in claim 2, further comprising a fine distortion identification circuit configured to receive the output signal of the non-linear amplifier and to generate second updated coefficients to be used by the fine distortion compensator.

4. The transmitting device as set forth in claim 3, further comprising:
a first summing circuit configured to receive the input signal and an output of the coarse distortion identification circuit and to generate an output signal; and
a first adaptive control algorithm processing block configured to receive the output signal of the first summing circuit and to generate a first control signal that adaptively adjusts the operation of the coarse distortion identification circuit.

5. The transmitting device as set forth in claim 4, further comprising:
a second summing circuit configured to receive the input signal and an output of the fine distortion identification circuit and to generate an output signal; and
a second adaptive control algorithm processing block configured to receive the output signal of the second summing circuit and to generate a second control signal that adaptively adjusts the operation of the fine distortion identification circuit.

6. For use in a wireless network configured to communicate with a plurality of mobile stations, a base station comprising:
a non-linear amplifier; and
a digital predistortion (DPD) circuit comprising:
a coarse distortion compensator configured to receive an input signal and to generate a coarse distortion compensation signal;
a fine distortion compensator configured to receive the input signal and to generate a fine distortion compensation signal; and
a summing circuit that combines the coarse distortion compensation signal and the fine distortion compensation signal to generate a pre-distorted input signal to the non-linear amplifier.

7. The base station as set forth in claim 6, further comprising a coarse distortion identification circuit configured to receive an output signal of the non-linear amplifier and to generate first updated coefficients to be used by the coarse distortion compensator.

8. The base station as set forth in claim 7, further comprising a fine distortion identification circuit configured to receive the output signal of the non-linear amplifier and to generate second updated coefficients to be used by the fine distortion compensator.

9. The base station as set forth in claim 8, further comprising:
a first summing circuit configured to receive the input signal and an output of the coarse distortion identification circuit and to generate an output signal; and
a first adaptive control algorithm processing block configured to receive the output signal of the first summing circuit and to generate a first control signal that adaptively adjusts the operation of the coarse distortion identification circuit.

10. The base station as set forth in claim 9, further comprising:
a second summing circuit configured to receive the input signal and an output of the fine distortion identification circuit and to generate an output signal; and
a second adaptive control algorithm processing block configured to receive the output signal of the second summing circuit and to generate a second control signal that adaptively adjusts the operation of the fine distortion identification circuit.

11. A transmitting device comprising:
a non-linear amplifier; and
a digital predistortion (DPD) circuit comprising:
a coarse distortion compensator configured to receive an input signal and to generate a coarse distortion compensation signal;
a fine distortion compensator configured to receive the coarse distortion compensation signal and to generate a pre-distorted input signal to the non-linear amplifier.

12. The transmitting device as set forth in claim 11, further comprising a coarse distortion identification circuit configured to receive an output signal of the non-linear amplifier and to generate first updated coefficients to be used by the coarse distortion compensator.

13. The transmitting device as set forth in claim 12, further comprising a fine distortion identification circuit configured to receive an output signal of the coarse distortion identification circuit and to generate second updated coefficients to be used by the fine distortion compensator.

14. The transmitting device as set forth in claim 13, further comprising:
a first summing circuit configured to receive the input signal and an output of the coarse distortion identification circuit and to generate an output signal; and
a first adaptive control algorithm processing block configured to receive the output signal of the first summing circuit and to generate a first control signal that adaptively adjusts the operation of the coarse distortion identification circuit.

15. The transmitting device as set forth in claim 14, further comprising:
a second summing circuit configured to receive the pre-distorted input signal to the non-linear amplifier and an output of the fine distortion identification circuit and to generate an output signal; and
a second adaptive control algorithm processing block configured to receive the output signal of the second summing circuit and to generate a second control signal that adaptively adjusts the operation of the fine distortion identification circuit.

16. For use in a wireless network configured to communicate with a plurality of mobile stations, a base station comprising:
a non-linear amplifier; and
a digital predistortion (DPD) circuit comprising:
a coarse distortion compensator configured to receive an input signal and to generate a coarse distortion compensation signal;
a fine distortion compensator configured to receive the coarse distortion compensation signal and to generate a pre-distorted input signal to the non-linear amplifier.

17. The base station as set forth in claim 16, further comprising a coarse distortion identification circuit configured to receive an output signal of the non-linear amplifier and to generate first updated coefficients to be used by the coarse distortion compensator.

18. The base station as set forth in claim 17, further comprising a fine distortion identification circuit configured to receive an output signal of the coarse distortion identification circuit and to generate second updated coefficients to be used by the fine distortion compensator.

19. The base station as set forth in claim 18, further comprising:
a first summing circuit configured to receive the input signal and an output of the coarse distortion identification circuit and to generate an output signal; and
a first adaptive control algorithm processing block configured to receive the output signal of the first summing circuit and to generate a first control signal that adaptively adjusts the operation of the coarse distortion identification circuit.

20. The base station as set forth in claim 19, further comprising:
a second summing circuit configured to receive the pre-distorted input signal to the non-linear amplifier and an output of the fine distortion identification circuit and to generate an output signal; and
a second adaptive control algorithm processing block configured to receive the output signal of the second summing circuit and to generate a second control signal that adaptively adjusts the operation of the fine distortion identification circuit.
